(19) United States
(12) Patent Application Publication
(10) Pub. No.: US 2016/0343173 A1
(43) Pub. Date: Nov. 24, 2016

(54) ACOUSTO-OPTICAL DISPLAY FOR AUGMENTED REALITY

(71) Applicant: DAQRI, LLC, Los Angeles, CA (US)

(72) Inventor: Brian Mullins, Altadena, CA (US)

(21) Appl. No.: 15/159,746

(22) Filed: May 19, 2016

Related U.S. Application Data
(60) Provisional application No. 62/164,192, filed on May 20, 2015.

(51) Int. Cl. G06T 19/20; G02B 27/01; G06T 19/00

(52) U.S. Cl. CPC G06T 19/20; G06T 19/006; G02B 27/0172; G02B 27/0103; G02B 2027/0127; G02B 2027/0174

(57) ABSTRACT

A system and method for an acousto-optical display for augmented reality are described. In some embodiments, a viewing device includes a transparent acousto-optical display and an augmented reality (AR) device. The transparent acousto-optical display displays virtual content. The augmented reality (AR) device dynamically adjusts optical properties of the transparent acousto-optical display and controls a depth of field of the virtual content displayed in the transparent acousto-optical display based on the optical properties.

### REFERENCE TO RELATED APPLICATION

This application claims the benefit of priority of U.S. Provisional Application No. 62/164,192 filed May 20, 2015, which is herein incorporated by reference in its entirety.

### TECHNICAL FIELD

The present application relates generally to the technical field of data processing and, in various embodiments, to an acousto-optical display for augmented reality devices.

### BACKGROUND

Holography enables three-dimensional (3D) images to be recorded in an optical medium for later reconstruction and display. Typically, a hologram is constructed by optical interference of two coherent laser beams in a film or a grating. As such the laser recording imparts static optical properties such as fixed depth encoded lights in the grating. The characteristics of the grating do not change once the recording is performed. As such, static optical properties of gratings can be difficult to use in Augmented Reality (AR) devices since the user's relative position is dynamic. AR devices allow users to observe a scene while simultaneously seeing relevant virtual content that may be aligned to items, images, objects, or environments in the field of view of the device or user. However, the user may move the devices relative to the items and stationary objects in space. Since the depth of field for the virtual content is fixed based on the recorded grating, the user may perceive a disparity between the real object and the virtual content.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating a system for acousto-optical display for augmented reality, in accordance with some example embodiments;

FIG. 2 is a block diagram illustrating an augmented reality device coupled to a transparent acousto-optical display, in accordance with some example embodiments;

FIG. 3 is a block diagram illustrating an augmented reality rendering module, in accordance with some example embodiments;

FIG. 4 is a block diagram illustrating a dynamic depth encoder, in accordance with some example embodiments;

FIG. 5 is a block diagram illustrating a server, in accordance with some example embodiments;

FIG. 6 is an interaction diagram illustrating interactions between a viewing device and a server, in accordance with some example embodiments;

FIG. 7 is a flowchart illustrating a method of controlling optical properties of a display of an augmented reality device, in accordance with some example embodiments;

FIG. 8 is a flowchart illustrating a method for adjusting a size of an augmented reality content in a display of an augmented reality device, in accordance with some example embodiments;

FIG. 9 is a flowchart illustrating another method of controlling optical properties of a display of an augmented reality device, in accordance with some example embodiments;

FIG. 10A is a diagram illustrating a first depth of field of a virtual object in a display of an augmented reality device, in accordance with some example embodiments;

FIG. 10B is a diagram illustrating a second depth of field of a virtual object in a display of an augmented reality device, in accordance with some example embodiments;

FIG. 11 is a diagram illustrating another depth of field of a virtual object in a display of an augmented reality device, in accordance with some example embodiments;

FIG. 12 is a block diagram of an example computer system on which methodologies described herein may be executed, in accordance with some example embodiments; and

FIG. 13 is a block diagram illustrating a mobile device, in accordance with some example embodiments.

### DETAILED DESCRIPTION

Example methods and systems of visual inertial navigation for augmented reality device are disclosed. In the following description, for purposes of explanation, numerous specific details are set forth in order to provide a thorough understanding of example embodiments. It will be evident, however, to one skilled in the art that the present embodiments may be practiced without these specific details.

AR applications allow a user to experience information, such as in the form of a virtual object such as a three-dimensional virtual object overlaid on an image of a physical object captured with a camera of a viewing device. The physical object may include a visual reference (e.g., a recognized image, pattern, or object) that the augmented reality application can identify. A visualization of the additional information, such as the three-dimensional virtual object overlaid or engaged with an image of the physical object, is generated in a display of the viewing device. The three-dimensional virtual object may be selected based on the recognized visual reference or captured image of the physical object. A rendering of the visualization of the three-dimensional virtual object may be based on a position of the display relative to the visual reference. Other augmented reality applications allow a user to experience visualization of the additional information overlaid on top of a view or an image of any object in the real physical world. The virtual object may include a three-dimensional or a two-dimensional virtual object. For example, the three-dimensional virtual object may include a three-dimensional model of a toy or an animated dinosaur. The two-dimensional virtual object may include a two-dimensional view of a dialog box, menu, or written information such as statistics information for properties or physical characteristics of the object (e.g., temperature, humidity, color). An image of the virtual object may be rendered at the viewing device or at a server in communication with the viewing device.

A user may view the virtual object visually perceived as an overlay onto the image or a view of the real-world object using a viewing device. The viewing device may include a mobile computing device such as a smartphone, a head mounted display system, computing glasses, and other types of wearable devices. The viewing device may include a system for sample-based color extraction for AR. In one example embodiment, the a viewing device includes a transparent acousto-optical display and an augmented reality device. The transparent acousto-optical display displays a virtual content. The augmented reality device includes an augmented reality application that dynamically adjusts optical properties of the transparent acousto-optical display to control a depth of field of the virtual content displayed in the transparent acousto-optical display.

The transparent acousto-optical display includes a transparent display coupled to an optical element. The AR application dynamically adjusts optical properties of the optical element to control the depth of field of the virtual content displayed in the transparent display.

In one example embodiment, the AR device includes a sensor, a display controller, and an acousto-optical modulator. The sensor captures an image of an object viewed through the transparent acousto-optical display, and determines a depth of the object relative to the transparent acousto-optical display. The display controller is coupled to the transparent display and communicates the virtual content to be displayed in the transparent display. The acousto-optical modulator is coupled to the optical element. The acousto-optical modulator generates and modulates a frequency of a signal to the optical element to dynamically adjust a density of a material of the optical element to affect diffraction properties of the optical element. The diffraction properties of the optical element affect the depth of field of the virtual content displayed in the transparent display.

The AR application includes comprises a recognition module, an AR rendering module, and a dynamic depth encoder. The recognition module identifies the object in the image captured with the sensor. The AR rendering module retrieves the virtual content associated with the object, and communicates a three-dimensional model of the virtual content to the display controller. The dynamic depth encoder determines the frequency of the signal based on the depth of the object relative to the transparent acousto-optical display. The dynamic depth encoder communicates the determined frequency of the signal to the acousto-optical modulator.

In one example embodiment, the AR rendering module accesses the three-dimensional model of the virtual content from a library of virtual content. The AR rendering module also renders the three-dimensional model of the virtual content. The dynamic depth encoder computes a size of the three-dimensional model of the virtual content based on the depth of the object. The dynamic depth encoder also computes a depth of field of the three-dimensional model of the virtual content based on the depth of the object.

In another example embodiment, the dynamic depth encoder monitors the depth of the object and dynamically adjusts at least one of a combination of the size of the three-dimensional model of the virtual content and the depth of field of the three-dimensional model of the virtual content based on the monitored depth of the object.

The transparent display comprises at least one of a combination of a transparent organic light-emitting diode (OLED) and a reflective display coupled to a projection device external to the reflective display. The optical element comprises at least one of a combination of a transparent waveguide and a holographic grating. The viewing device comprises a transparent visor of a helmet, the transparent visor including the transparent acousto-optical display.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

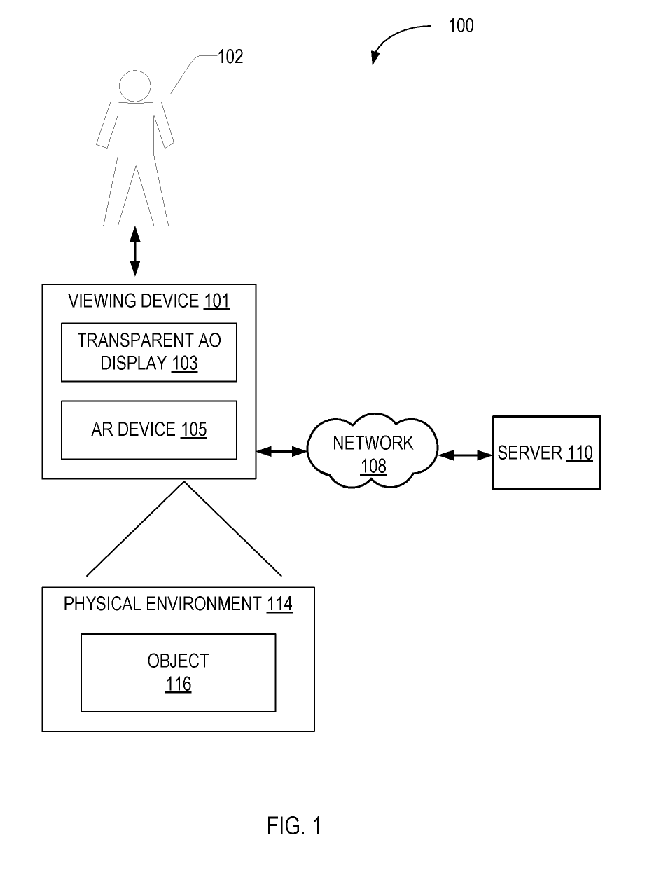

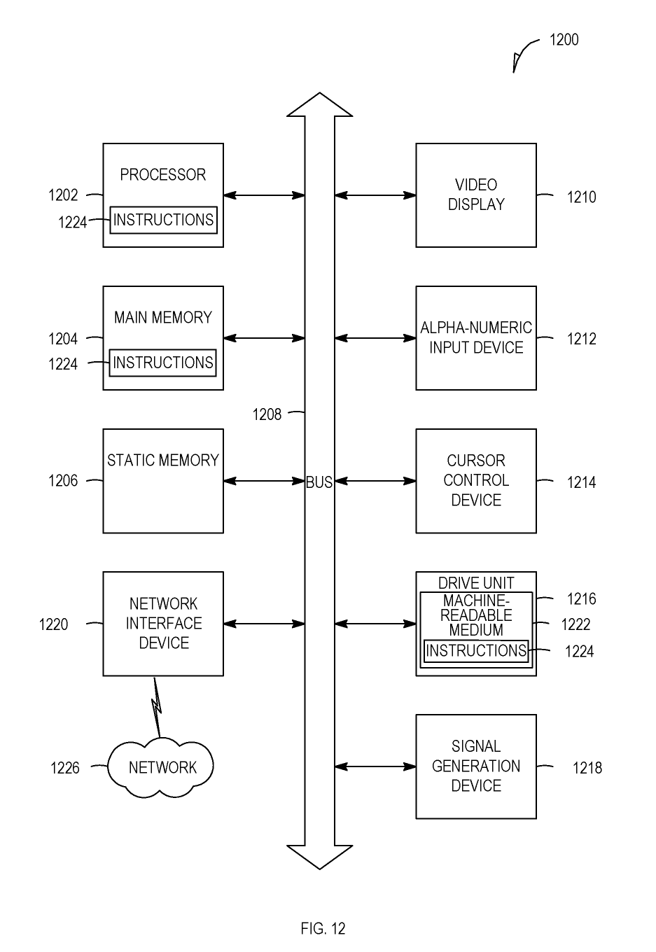

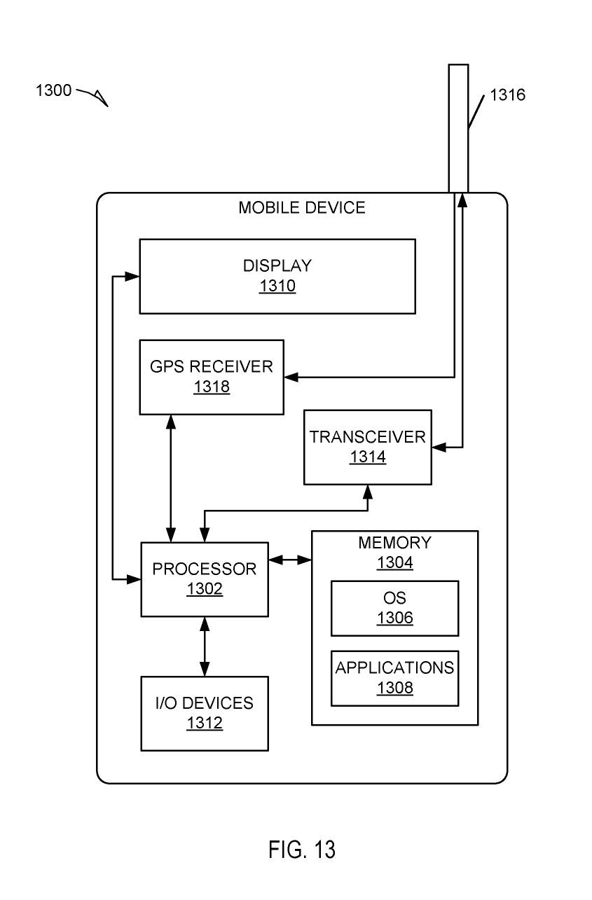

FIG. 1 is a block diagram illustrating a system for acousto-optical display for augmented reality, in accordance with some example embodiments. A network environment 100 includes a viewing device 101 and a server 110, communicatively coupled to each other via a network 108. The viewing device 101 and the server 110 may each be implemented in a computer system, in whole or in part, as described below with respect to FIGS. 12 and 13. In another example, the viewing device 101 is a standalone device capable of operating without communicating with the server 110.

The server 110 may be part of a network-based system. For example, the network-based system includes a cloud-based server system that provides additional information, such as three-dimensional models or other virtual objects and corresponding characteristics, to the viewing device 101 based on an identification of objects being viewed using the viewing device 101. In another example, the server 110 retrieves virtual content based on data from sensors (e.g., gyroscope, compass, etc.) of the viewing device 101 or data from sensors external to the viewing device 101 (e.g., external cameras).

A user 102 may utilize the viewing device 101 to view a real world physical environment 114 (e.g., a room, a desk, a hallway) having one or more physical objects (e.g., object 116—such as a piece of paper, a magazine, a child's toy, a building). The user 102 may be a human user (e.g., a human being), a machine user (e.g., a computer configured by a software program to interact with the viewing device 101), or any suitable combination thereof (e.g., a human assisted by a machine or a machine supervised by a human). The user 102 is not part of the network environment 100, but is associated with the viewing device 101 and may be a user 102 of the viewing device 101. For example, the viewing device 101 may be a computing device with a transparent display for use in a smartphone, a tablet computer, a wearable computing device (e.g., watch or glasses), or a head-mounted computing device (e.g., helmet). A tablet computer may be held up to view the object 116 through a transparent display of the tablet computer. The computing device may be hand held or may be removably mounted to the head of the user 102. In one example embodiment, the viewing device 101 includes a transparent acousto-optical display 103 and an AR device 105. The transparent acousto-optical display 103 displays virtual content generated by the AR device 105. The transparent acousto-optical display 103 may be semi-transparent or transparent such as in lenses of wearable computing glasses or the visor of a helmet.

The transparent acousto-optical display 103 may include any type of transparent display (e.g., transparent OLED) to enable the user 102 to view the object 116 directly through the viewing device 101. In another example, the transparent acousto-optical display 103 includes a semi-transparent screen that reflects images projected onto its surface. An external projector may project images of the virtual content onto the semi-transparent screen. The transparent acousto-optical display 103 also includes a virtual lens that adjusts a depth of field for the displayed virtual content. The virtual lens includes an optical element with optical properties that can be dynamically adjusted on the fly. For example, the optical element may include a material such as quartz or glass that is connected to a piezo-electric transducer. An oscillating electric signal drives the transducer to vibrate, which creates sound waves in the glass. The moving periodic planes of expansion and compression change the index of refraction in the glass. Light passing through the glass scatters off the resulting periodic index modulation and interference occurs. The depth of field of light reflected off the object being viewed may be adjusted by modulating the frequency of the signal to the transducer. In one example, the transparent acousto-optical display 103 includes a high-bandwidth (high-resolution) light modulation device for modulating the density of a transparent grating at a high refresh rate. Other embodiments of modifying the depth of field include using wave guides in substrates, or nano-based material that excite to laser. In one embodiment, the entire coding of optical element is modulated. Multiple depths may be simultaneously recorded across the entire area of the optical element. RF modulation may be applied to the transparent display 103 to control the depth of field throughout the entire transparent display 103.

The user 102 may be a user of the AR device 105 in the viewing device 101 and at the server 110. The AR device 105 in the viewing device 101 may optionally communicate with an AR application in the server 110 to access AR content. The AR device 105 provides the user 102 with an augmented experience triggered by the identified or recognized object 116 in the physical environment 114. In another embodiment, the object 116 is not recognized, but physical features or characteristics of the object 116 are identified to generate the augmented experience. The augmented experience may be in the form of a virtual object based on the captured image of the real world object 116. The virtual object may already have predefined behaviors such as flaming or crackling fire from the virtual fire log, or splashes from crashing waves. The AR device 105 generates the virtual content to be displayed in the transparent acousto-optical display 103 and dynamically control a depth of field of the virtual content. In one example, the AR device 105 modulates the frequency of an electrical signal to a transducer in the transparent acousto-optical display 103 to the control the depth of field of the virtual content being displayed.

The physical environment 114 may include identifiable objects such as a two-dimensional physical object (e.g., a picture of a dog), a three-dimensional physical object (e.g., a toy or an action figure), a location (e.g., at the bottom floor of a house), or any references (e.g., perceived corners of walls or furniture) in the real world physical environment 114. For example, the user 102 may point a camera of the viewing device 101 to capture an image of real world object (e.g., object 116).

In one example embodiment, the objects in the image are tracked and recognized locally in the viewing device 101 using a local context recognition dataset or any other previously stored dataset of the augmented reality application of the viewing device 101. The objects in the image may be recognized patterns on a drawing (e.g., dogs, characters, scenery). The local context recognition dataset module may include a library of virtual objects associated with real-world physical objects or references. In one example, the viewing device 101 identifies feature points in an image of the object 116 to determine different planes (e.g., edges, corners, and surface). The viewing device 101 also identifies tracking data related to the object 116 (e.g., GPS location, orientation and position of the object 116 relative to the viewing device 101, etc.). In another example embodiment, if the captured image is not recognized locally at the viewing device 101, the viewing device 101 downloads additional information (e.g., the three-dimensional model) corresponding to the captured image from a database of the server 110 over the network 108.

In another example embodiment, the object 116 in the captured image is tracked and recognized remotely at the server 110 using a remote context recognition dataset or any other previously stored dataset of an AR application at the server 110. The remote context recognition dataset module may include, for example, a library of virtual objects associated with the image of the object 116. For example, the viewing device 101 may have a limited library of a context recognition dataset. If the viewing device 101 does not recognize a pattern or a drawing, the viewing device 101 sends an image of the drawing to the server 110 to determine a new virtual object associated with a portion of the image of the drawing. The viewing device 101 then downloads the new virtual object from the server 110. In another example, the viewing device 101 recognizes the object 116 and queries the server 110 for updates to virtual objects associated with the object 116. For example, the viewing device 101 recognizes a landmark building and queries the server 110 for additional effects (e.g., virtual King Kong climbing the landmark building).

In another example embodiment, the viewing device 101 includes sensors to measure physical properties of the object 116. Examples of measured physical properties may include and but are not limited to color, shades, weight, pressure, temperature, velocity, direction, position, intrinsic and extrinsic properties, acceleration, and dimensions. The sensors may also be used to track the location, movement, and orientation of the viewing device 101. The sensors may include optical sensors (e.g., depth-enabled 3D camera), wireless sensors (Bluetooth, Wi-Fi), GPS sensor, and audio sensor to determine the location of the viewing device 101, the orientation of the viewing device 101 to track what the user 102 is looking at (e.g., a direction at which the viewing device 101 is pointed, e.g., the viewing device 101 is pointed towards a drawing on a wall or on a table, markings on a floor). The sensors may be embedded in a head-mounted device.

In another example embodiment, data from the internal sensors in the viewing device 101 may be used for analytics data processing at the server 110 (or another server) for analysis on usage and how the user 102 is interacting with the physical environment 114. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 held the viewing device 101 when looking at the physical or virtual object, with which features of the virtual object the user 102 interacted (e.g., such as whether a user 102 tapped on a part of the virtual object—a user pets a virtual dog on the head), and any suitable combination thereof. The tracking may be performed by tracking the position of the viewing device 101 relative to the object A 116, or by using front cameras in the viewing device 101 to track an eye gaze of the user 102.

The viewing device 101 may offload computation to the server 110 based on the available resources at the viewing device 101. Specific computations may be allocated between the viewing device 101 and the server 110 in real time based on available resources at each device and changing network conditions (e.g., limited bandwidth).

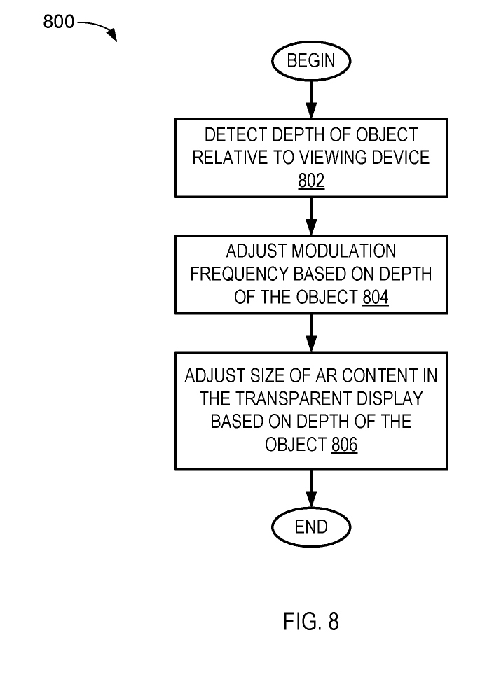

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIGS. 7-9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., device 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

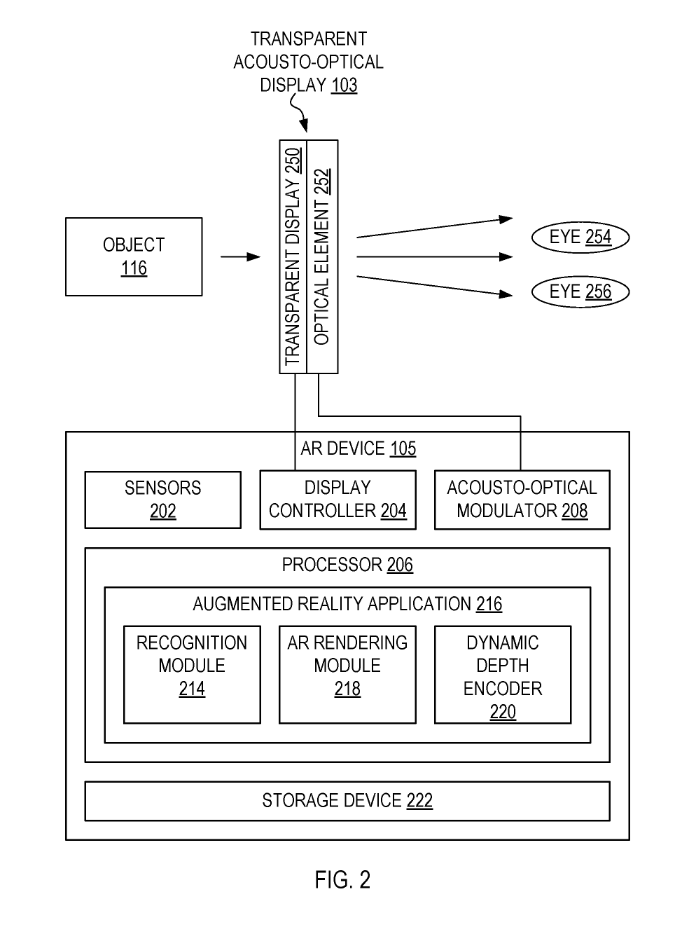

FIG. 2 is a block diagram illustrating the augmented reality device 105 coupled to the transparent acousto-optical display 103, in accordance with some example embodiments. The transparent acousto-optical display 103 includes a transparent display 250 connected to an optical element 252 (or medium). Light reflected off the object 116 travels through the transparent display 250 and the optical element 252 to eyes 254, 256 of the user 102. The transparent display 250 may include for example a transparent OLED. In other embodiments, the transparent display 250 includes a reflective surface to reflect an image projected onto the surface of the transparent display 250 from an external source such as an external projector. In another example, the transparent display 250 includes a touchscreen display configured to receive a user input via a contact on the touchscreen display. The transparent display 250 may include a screen or monitor configured to display images generated by the processor 206. In another example, the transparent display 250 may be transparent or semi-opaque so that the user 102 can see through the transparent display 250 (e.g., a Heads-Up Display).

The optical element 252 may include an acousto-optical transducer for modifying optical properties of the optical element 252 at a high bandwidth. For example, the optical properties of the optical element 252 may be modified at a rate high enough so that individual changes are not discernable to the naked eyes 254, 256 of the user 102. For example, the depth of field may be modulated at a rate of 60 hz.

The AR device 105 includes sensors 202, a display controller 204, an acousto-optical modulator 208, a processor 206, and a storage device 222. For example, the AR device 105 may be part of a wearable computing device (e.g., glasses or a helmet), a desktop computer, a vehicle computer, a tablet computer, a navigational device, a portable media device, or a smart phone of a user. The user may be a human user (e.g., a human being), a machine user (e.g., a computer configured by a software program to interact with the viewing device 101), or any suitable combination thereof (e.g., a human assisted by a machine or a machine supervised by a human).

The sensors 202 include, for example, a proximity or location sensor (e.g., Near Field Communication, GPS, Bluetooth, Wi-Fi), an optical sensor (e.g., a camera), an orientation sensor (e.g., a gyroscope), an audio sensor (e.g., a microphone), or any suitable combination thereof. For example, the sensors 202 may include a rear-facing camera and a front-facing camera in the viewing device 101. It is noted that the sensors 202 described herein are for illustration purposes; the sensors 202 are thus not limited to the ones described. The sensors 202 may be used to generate internal tracking data of the viewing device 101 to determine what the viewing device 101 is capturing or looking at in the real physical world.

The sensors 202 may also include a first depth sensor to measure the distance of the object 116 from the transparent display 250. The sensors 202 include a second depth sensor to measure the distance between the optical element 252 and the eyes 254, 256.

In another example, the sensors 202 may include an eye tracking device to track a relative position of the eye. The eye position data may be fed into the display controller 204 and the acousto-optical modulator 208 to generate a higher resolution of the virtual object and further adjust the depth of field of the virtual object at a location in the transparent display corresponding to a current position of the eye.

The display controller 204 communicates data signals to the transparent display 250 to display the virtual content. In another example, the display controller 204 communicates data signals to an external projector to project images of the virtual content onto the transparent display 250. The display controller 204 includes a hardware that converts signals from the processor 206 to display signals for the transparent display 250.

The acousto-optical modulator 208 generates and modulates an electrical signal to the transducer of the optical element 252 to dynamically change optical properties such as refraction index of the optical element 252 at rate faster than perceived with human eyes 254, 256. The acousto-optical modulator 208 is one example of a modulation of the optical element 252 in the transparent acousto-optical display 103. Other means for changing the optical characteristics of the optical element 252 may be used to affect the refraction index of the optical element 252. The acousto-optical modulator 208 operates in conjunction with the display controller 204 to affect a depth of field of the virtual content display in the transparent display 250. The display controller 204 modifies the display of the virtual content in the transparent display 250 as the user moves around the object 116. The acousto-optical modulator 208 modifies the depth of the field of the virtual content perceived by the eyes 254, 256 based on the user's movement.

The processor 206 may include an AR application 216 for processing an image of a real world physical object (e.g., object 116) and for generating a virtual object in the transparent display 250 of the transparent acoutso-opical display 103 corresponding to the image of the object 116. In one example embodiment, the AR application 216 may include a recognition module 214, an AR rendering module 218, and a dynamic depth encoder 220.

The recognition module 214 identifies the object that the viewing device 101 is pointed to. The recognition module 214 may detect, generate, and identify identifiers such as feature points of the physical object being viewed or pointed at by the viewing device 101 using an optical device (e.g., sensors 202) of the viewing device 101 to capture the image of the physical object. As such, the recognition module 214 may be configured to identify one or more physical objects. The identification of the object may be performed in many different ways. For example, the recognition module 214 may determine feature points of the object based on several image frames of the object. The recognition module 214 also determines the identity of the object using any visual recognition algorithm. In another example, a unique identifier may be associated with the object. The unique identifier may be a unique wireless signal or a unique visual pattern such that the recognition module 214 can look up the identity of the object based on the unique identifier from a local or remote content database. In another example embodiment, the recognition module 214 includes a facial recognition algorithm to determine an identity of a subject or an object.

Furthermore, the recognition module 214 may be configured to determine whether the captured image matches an image locally stored in a local database of images and corresponding additional information (e.g., three-dimensional model and interactive features) in the storage device 222 of the AR device 105. In one embodiment, the recognition module 214 retrieves a primary content dataset from the server 110, and generates and updates a contextual content dataset based on an image captured with the viewing device 101.

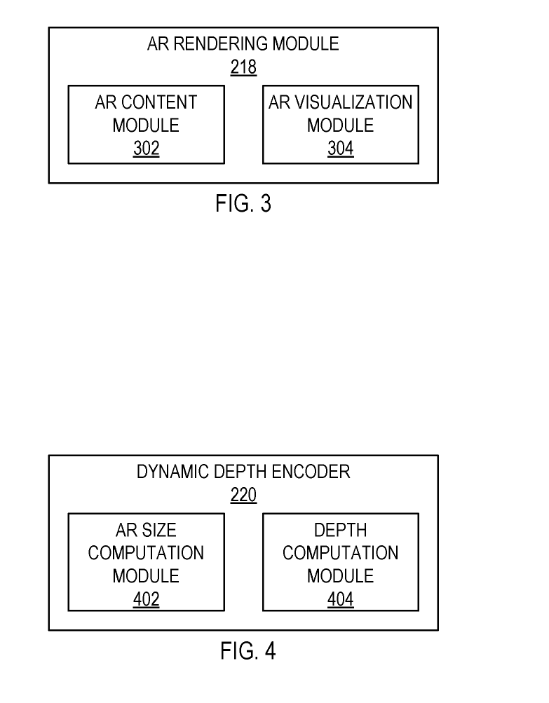

The AR rendering module 218 generates the virtual content based on the recognized or identified object 116. For example, the virtual content may include a three-dimensional rendering of King Kong based on a recognized picture of the Empire State building. In one example embodiment, the AR rendering module 218 includes an AR content module 302 and an AR visualization module 304 as illustrated in FIG. 3.

The AR content module 302 retrieves the virtual content associated with the identified object 116. The virtual content includes, for example, a three-dimensional model (e.g., 3D model of King Kong). Furthermore, the virtual content can include effects, animations, or behaviors, or colors of the virtual content. For example, a three-dimensional model of King Kong may be animated to show him smashing helicopters circling King Kong at the top of the Empire State building. In another example, helicopters appear in more details as the user gets closer to the Empire State building. In another example, King Kong may appear calmer in response to specific voice commands (e.g., “calm down) of the user. The AR content module 302 may associate other characteristics with other predefined parameters based on data from the sensors 202. The virtual content may be stored locally in the storage device 222 or remotely in the server 110.

The AR visualization module 304 generates or modifies a visualization of the virtual content in the captured image of the real-world object. For example, the AR visualization module 304 renders a three-dimensional model of the virtual content in the display transparent display 250 of the viewing device transparent acouto-optical display 103. The user 102 of the viewing device 101 visually perceives the three-dimensional model as an overlay. For example, the user 102 may visually perceive a virtual dog sitting on top of a real world dog house. The AR visualization module 304 communicates display signals of a 3D model of the virtual dog to the display controller 204. In turn, the display controller 204 controls the transparent display 250 to display the virtual dog.

In another example embodiment, the AR visualization module 304 renders a visualization of the characteristic of the virtual content in the display 204 of the viewing device 101. The content and characteristic of the three-dimensional virtual model may be a function of data from sensors 202 of the AR device 105. For example, if one of the sensors 202 indicates a temperature of 40 degrees Fahrenheit at a specific location in a factory, the AR visualization module 304 generates a visualization of fast moving exit arrows correlated to the green pedestrian markings on the floor of the factory. As such, the nature and characteristics of the virtual content generated or accessed may be a function of a combination of a recognized object, a color of the recognized object, and data from sensors 202 of the AR device 105.

In one example embodiment, the AR visualization module 304 receives data from the server 110 to render the visualization. In another example embodiment, the AR visualization module 304 receives the rendered object. The AR visualization module 304 further determines the position and size of the rendered object to be displayed in relation to an image of the object. For example, the AR visualization module 304 places a virtual three-dimensional model of an animated heart with the size and position based on the image of the subject such that the animated heart is displayed on the chest area of the subject with the appropriate size. If the subject is wearing a red T shirt, the virtual three-dimensional model of an animated heart may be moving at a faster pace than a subject wearing a darker T shirt. The AR visualization module 304 may track the image of the subject and render the virtual object based on the position of the image of the subject in the transparent display 250 of the transparent acousto-optical display 103.

The viewing device 101 may access from a local memory a visualization model (e.g., vector shapes) corresponding to the image of the object (e.g., bridge). In another example, the viewing device 101 receives a visualization model corresponding to the image of the object from the server 110. The viewing device 101 then renders the visualization model to be displayed in relation to an image of the object being displayed in the viewing device 101 or in relation to a position and orientation of the viewing device 101 relative to the object. The AR visualization module 304 may adjust a position of the rendered visualization model in the transparent display 250 to correspond with the last tracked position of the object.

The AR visualization module 304 may include a local rendering engine that generates a visualization of a three-dimensional virtual object overlaid (e.g., superimposed upon, or otherwise displayed in tandem with) on an image of a physical object captured by a camera of the viewing device 101 in the transparent display 250 of the viewing device 101. A visualization of the three-dimensional virtual object may be manipulated by adjusting a position of the physical object (e.g., its physical location, orientation, or both) relative to the camera of the viewing device 101. Similarly, the visualization of the three-dimensional virtual object may be manipulated by adjusting a position of the camera of the viewing device 101 relative to the physical object.

In one example embodiment, the AR visualization module 304 retrieve three-dimensional models of virtual objects associated with a captured image of a real-world object. For example, the captured image may include a visual reference (also referred to as a marker) that consists of an identifiable image, symbol, letter, number, machine-readable code. For example, the visual reference may include a bar code, a quick response (QR) code, a pattern, or an image that has been previously associated with a three-dimensional virtual object (e.g., an image that has been previously determined to correspond to the three-dimensional virtual object).

In one example embodiment, the AR visualization module 304 identifies the physical object (e.g., a physical telephone), accesses virtual functions (e.g., increase or lower the volume of a nearby television) associated with physical manipulations (e.g., lifting a physical telephone handset) of the physical object, and generates a virtual function corresponding to a physical manipulation of the physical object.

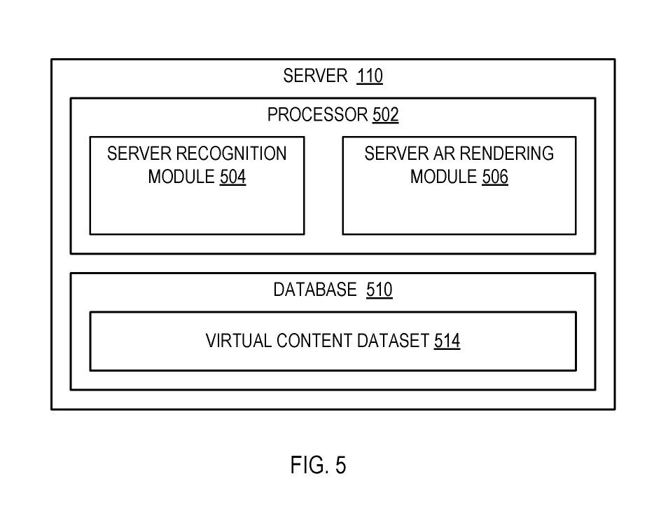

Referring back to FIG. 2, the dynamic depth encoder 220 determines the frequency of the signal based on the depth of the object relative to the transparent acousto-optical display, and communicates the determined frequency of the signal to the acousto-optical modulator. The dynamic depth encoder 220 adjusts the modulation frequency of the electrical signal to the optical element 252 to control refraction indexes of the optical element 252 to manipulate depth of field of the virtual object. The dynamic depth encoder 220 adjusts the modulation frequency of the electrical signal at a high rate or frequency so that the user does not perceive individual changes in the depth of field. The dynamic depth encoder 220 sends control signal to the acousto-optical modulator 208 that generates and modulate electrical signal to the transducer of the optical element 252 in response to the control signal. In another example, the dynamic depth encoder 220 adjusts the depth of field based on sensor data from the sensors 202. For example, the depth of field may be increased based on the distance between the transparent display 250 and the object 116. In another example, the depth of field may be adjusted based on a direction in which the eyes are looking. In one example embodiment, the dynamic depth encoder 220 includes an AR size computation module 402 and a depth computation module 404 as illustrated in FIG. 4.

The AR size computation module 402 computes a size of the three-dimensional model of the virtual content based on the depth of the object or distance of the object 116 to the transparent display 250. For example, the size of a virtual King Kong may become larger as the viewing device 101 gets closer to the Empire State building.

The depth computation module 404 computes a depth of field of the three-dimensional model of the virtual content based on the depth of the object or the distance between the object 116 and the transparent display 250. The virtual object may be manipulated to be seen as blurry if the distance between the object 116 and the transparent display 250 exceeds a predefined threshold or distance. In another example embodiment, the depth computation module 404 monitors the depth of the object 116 and to dynamically adjust at least one of a combination of the size of the three-dimensional model of the virtual content and the depth of field of the three-dimensional model of the virtual content based on the monitored depth of the object.

Referring back to FIG. 2, the storage device 222 may be configured to store a database of identifiers of physical objects, tracking data, and corresponding virtual objects having colors and characteristics a function of a color of a recognized physical object. In another embodiment, the database may also include visual references (e.g., images) and corresponding experiences (e.g., three-dimensional virtual objects, interactive features of the three-dimensional virtual objects, animations of the three-dimensional virtual objects, characteristics of the three-dimensional virtual objects). For example, the visual reference may include a machine-readable code or a previously identified image (e.g., a picture of a superhero character). The previously identified image of the superhero character may correspond to a three-dimensional virtual model of the superhero character that can be viewed from different angles by manipulating the position of the viewing device 101 relative to the picture of the shoe. Features or powers of the three-dimensional virtual superhero character may be displayed based on the detected sample color values of a real-world object.

In one embodiment, the storage device 222 includes a primary content dataset, a contextual content dataset, and a visualization content dataset. The primary content dataset includes, for example, a first set of images and corresponding experiences (e.g., interaction with three-dimensional virtual object models). For example, an image may be associated with one or more virtual object models. The primary content dataset may include a core set of images or the most popular images determined by the server 110. The core set of images may include a limited number of images identified by the server 110. For example, the core set of images may include the images depicting covers of the ten most popular drawings or cartoons and their corresponding experiences (e.g., virtual objects that represent the ten most drawings or cartoons). In another example, the server 110 may generate the first set of images based on the most popular or often scanned images received at the server 110. Thus, the primary content dataset does not depend on objects or images scanned by the recognition module 214 of the viewing device 101.

The contextual content dataset includes, for example, a second set of images and corresponding experiences (e.g., three-dimensional virtual object models) retrieved from the server 110. For example, images captured with the viewing device 101 that are not recognized (e.g., by the server 110) in the primary content dataset are submitted to the server 110 for recognition. If the captured image is recognized by the server 110, a corresponding experience may be downloaded at the viewing device 101 and stored in the contextual content dataset. Thus, the contextual content dataset relies on the context in which the viewing device 101 has been used. As such, the contextual content dataset depends on objects or images scanned by the recognition module 214 of the viewing device 101.

In one embodiment, the viewing device 101 may communicate over the network 108 with the server 110 to retrieve a portion of a database of visual references, corresponding three-dimensional virtual objects, and corresponding features of the three-dimensional virtual objects. The network 108 may be any network that enables communication between or among machines, databases, and devices (e.g., the viewing device 101).

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

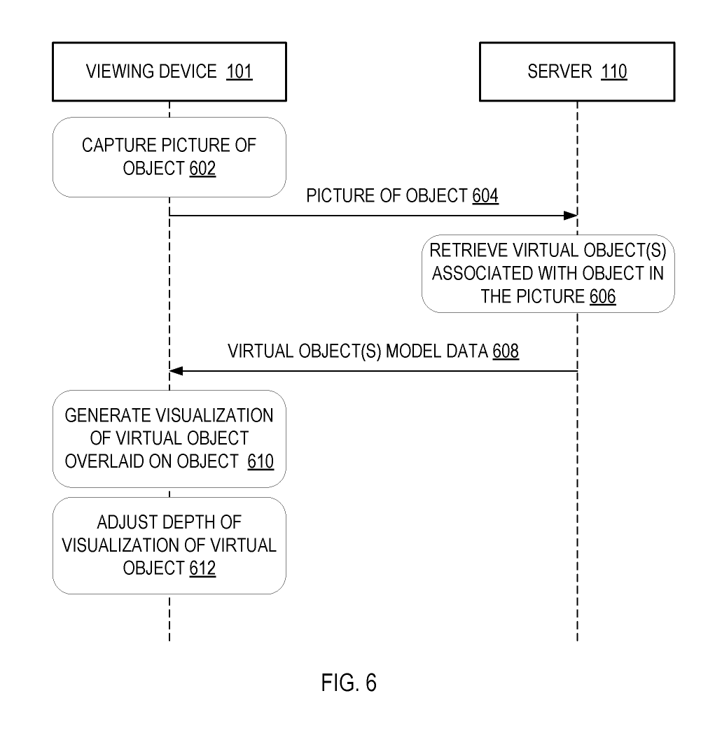

FIG. 5 is a block diagram illustrating modules (e.g., components) of the server 110. The server 110 includes a processor 502 and a database 510. The processor 502 includes a server recognition module 504, and a server AR rendering module 506. The server recognition module 504 operates in a similar way to the recognition module 214 of the AR device 105. For example, the server recognition module 504 identifies the object 116 based on a captured image received from the viewing device 101. In another example, the AR device 105 already has identified the object 116 and provides the identification information to the server recognition module 504.

The server AR rendering module 506 also operates in a similar way as the AR rendering module 218 of the AR device 105. For example, the server AR rendering module 506 retrieves the virtual content based on the object identified in the received image from the viewing device 101 and renders the 3D model of the virtual content.

The database 510 may store a virtual content dataset 514. The virtual content dataset 514 may store a primary content dataset and a contextual content dataset. The primary content dataset comprises a first set of images, colors, and corresponding virtual object models. The server recognition module 504 determines that a captured image received from the viewing device 101 is not recognized in the primary content dataset, and generates the contextual content dataset for the viewing device 101. The contextual content dataset may include a second set of virtual object models. The virtual content dataset 514 includes models of virtual objects (e.g., a three-dimensional model of an object) to be generated upon receiving a notification associated with an image of a corresponding physical object. The characteristics of virtual content dataset include a table of identified objects and/or colors with characteristics or behaviors (e.g., animation, effects, sound, music, etc.) that correspond to the sample color values from the captured image.

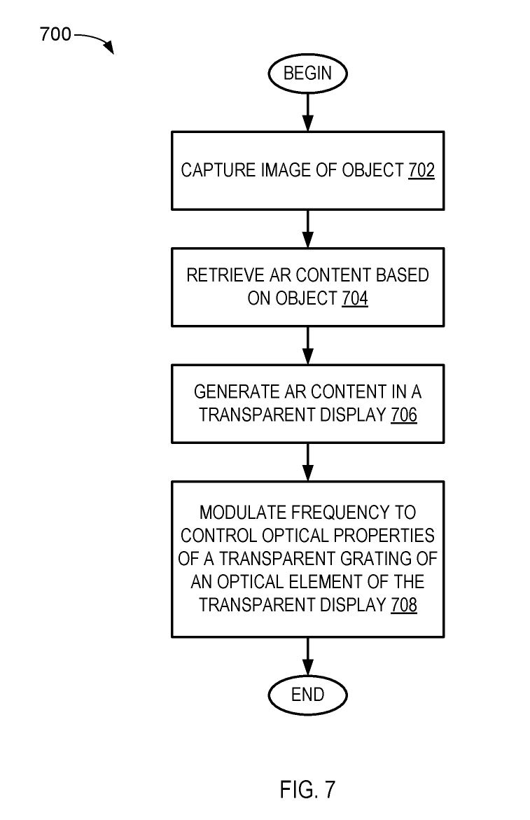

FIG. 6 is an interaction diagram illustrating interactions between the viewing device 101 and the server 110, in accordance with some example embodiments. At operation 602, the viewing device 101 takes a picture of the object. At operation 604, the viewing device 101 sends the picture of the object to the server 110. At operation 606, the server 110 retrieves the virtual object associated with the object in the picture. At operation 608, the server 110 sends the virtual object model data (e.g., 3D model) to the viewing device 101 for rendering. At operation 610, the viewing device 101 generates a visualization of the virtual object in the transparent display 250. At operation 612, the viewing device 101 adjusts the depth of field for the virtual object by adjusting a modulation frequency to a transducer connected to the optical element 252 of the transparent acousto-optical display 103 of FIG. 2.

FIG. 7 is a flowchart illustrating a method 700 of controlling optical properties of a display of an augmented reality device, in accordance with some example embodiments. At operation 702, the image of the object 116 is captured. For example, the viewing device 101 includes a camera that captures an image of the object 116. In one example embodiment, operation 702 may be implemented with the recognition module 214 in the AR device 105 of FIG. 2.

At operation 704, the virtual content associated with the object is retrieved. In one example embodiment, operation 704 may be implemented with the recognition module 214 in the AR device 105 of FIG. 2.

At operation 706, the transparent display 706 displays the virtual content previously retrieved at operation 704. In one example embodiment, operation 706 may be implemented with the AR rendering module 218 in the AR device 105 of FIG. 2.

At operation 708, the AR device 105 modulates frequencies to control optical properties of a transparent grating of the optical element 252 of the transparent acousto-optical display 103. In one example embodiment, operation 708 may be implemented using the dynamic depth encoder 220 of the AR device 105 of FIG. 2 to modulate the frequency of electrical signals to the optical element 252 to adjust the depth of field of the virtual content.

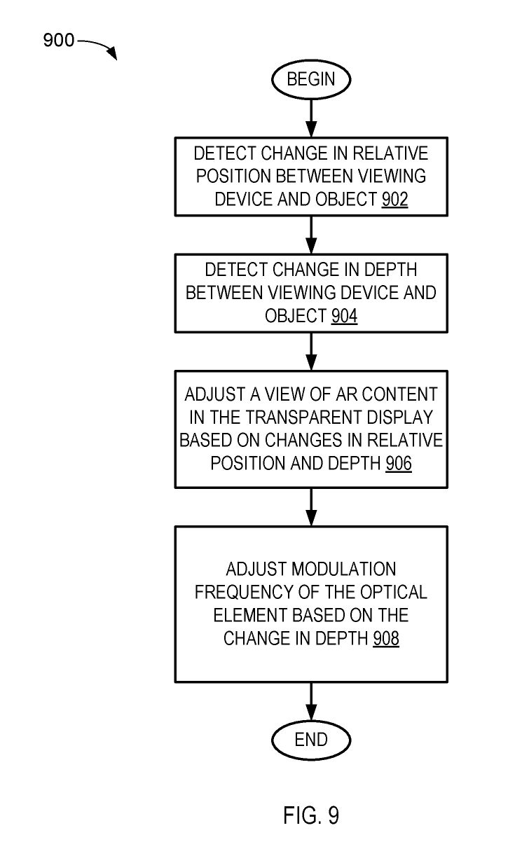

FIG. 8 is a flowchart illustrating a method 800 for adjusting a size of an augmented reality content in a display of an augmented reality device, in accordance with some example embodiments. At operation 802, the AR device 105 detects a depth of an object relative to the viewing device 101. In one example embodiment, operation 802 may be implemented using the dynamic depth encoder 220 of the AR device 105 in FIG. 2.

At operation 804, the AR device 105 adjusts the modulation frequency based on the depth or distance to the object. In one example embodiment, operation 804 may be implemented using the depth computation module 404 of the dynamic depth encoder 220 in FIG. 4.

At operation 806, the AR device 105 adjusts the size of the AR content in the transparent display based on the depth or distance to the object. In one example embodiment, operation 806 may be implemented using the AR size computation module 402 of the dynamic depth encoder 220 in FIG. 4.

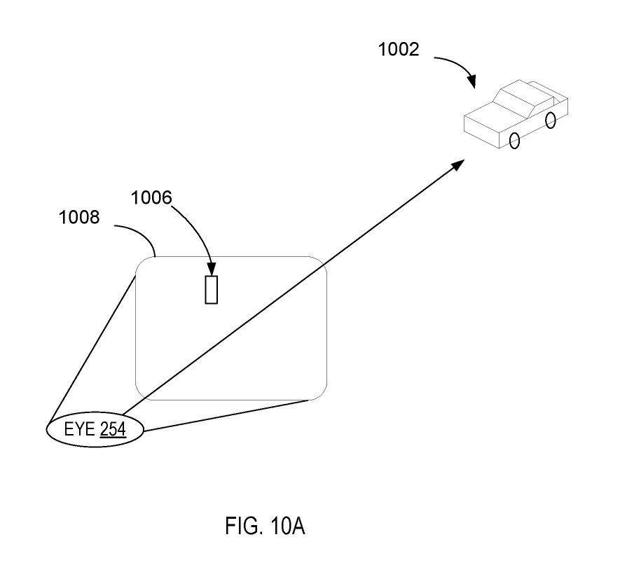

FIG. 9 is a flowchart illustrating another method of controlling optical properties of a display of an augmented reality device, in accordance with some example embodiments. At operation 902, the AR device 105 detects a change in relative positions between the viewing device 101 and the object 116. For example, the AR device 105 may use sensors 202 (e.g., gyroscope) to determine whether the AR device 105 is above and pointed downward towards the object 116.

At operation 904, the AR device 105 detects a change in depth (or distance) between the viewing device 101 and the object 116. In one example embodiment, operation 904 may be implemented using the sensors 202 of the AR device 105 in FIG. 2.

At operation 906, the AR device 105 adjusts a view of the AR content in the transparent display based on the changes in relative position and depth (or distance). In one example embodiment, operation 904 may be implemented using the AR rendering module 218 of the AR device 105 in FIG. 2. The AR rendering module 218 adjusts a rendering of the 3D model based on the changes in relative position and depth of the AR device 105.

At operation 908, the AR device 105 adjusts a modulation frequency of the optical element 252 based on the change in depth or distance to the object 116. In one example embodiment, operation 908 may be implemented using the dynamic depth encoder 220 of FIG. 2.

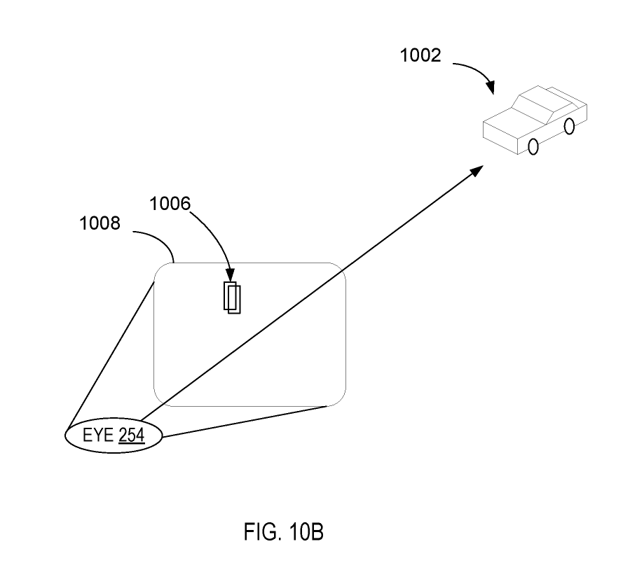

FIG. 10A is a diagram illustrating a first depth of field of a virtual object in a display of an augmented reality device, in accordance with some example embodiments. The eye 254 views a real world object, a car 1002, through a transparent display 1008. The transparent display 1008 generates a display of a virtual stop light 1006 so that the eye 254 perceives it to be next to the car 1002. The AR device 105 adjusts the depth of field of the virtual stop light 1006 to correspond with the depth of field of the car 1002.

FIG. 10B is a diagram illustrating a second depth of field of a virtual object in a display of an augmented reality device, in accordance with some example embodiments. In this example, the AR device 105 adjusts the depth of field of the virtual stop light 1006 so that it is different than the depth of field of the car 1002. For example, the display of the virtual stop light 1006 may become blurry, soft, or sharp in contrast to a view of the car 1002. As such, the virtual stop light 1006 may appear behind or in front of the car 1002 by adjusting the depth of field.

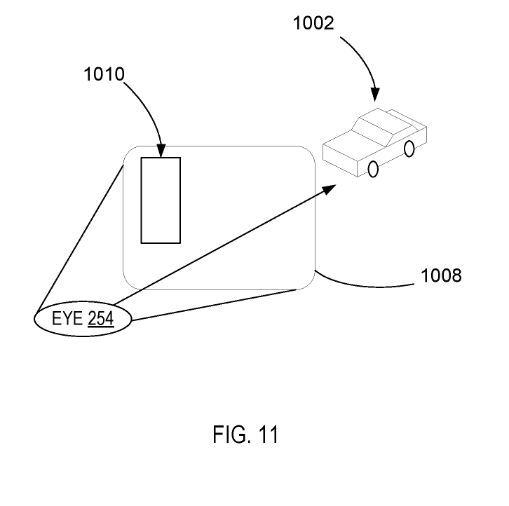

FIG. 11 is a diagram illustrating another depth of field of a virtual object in a display of an augmented reality device, in accordance with some example embodiments. In this example, the car 1002 is closer to the display 1008 than in FIG. 10A. As such, the AR device 105 adjusts the size of the AR content (the virtual stop light 1010) to be relatively larger than the size of the AR content when the car 1002 was far away. The transparent display 1008 generates a display of the larger virtual stop light 1010 so that the eye 254 still perceives it to be next to the car 1002. The AR device 105 may also adjusts the depth of field of the virtual stop light 1006.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 214 of FIG. 2) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 12 is a block diagram of a machine in the example form of a computer system 1200 within which instructions 1224 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a disk drive unit 1216, a signal generation device 1218 (e.g., a speaker) and a network interface device 1220.

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

### Example Mobile Device

FIG. 13 is a block diagram illustrating a mobile device 1300 that may employ the VIN state computation features of the present disclosure, according to an example embodiment. The mobile device 1300 may include a processor 1302. The processor 1302 may be any of a variety of different types of commercially available processors 1302 suitable for mobile devices 1300 (for example, an XScale architecture microprocessor, a microprocessor without interlocked pipeline stages (MIPS) architecture processor, or another type of processor 1302). A memory 1304, such as a random access memory (RAM), a flash memory, or other type of memory, is typically accessible to the processor 1302. The memory 1304 may be adapted to store an operating system (OS) 1306, as well as application programs 1308, such as a mobile location enabled application that may provide LBSs to a user 102. The processor 1302 may be coupled, either directly or via appropriate intermediary hardware, to a display 1310 and to one or more input/output (I/O) devices 1312, such as a keypad, a touch panel sensor, a microphone, and the like. Similarly, in some embodiments, the processor 1302 may be coupled to a transceiver 1314 that interfaces with an antenna 1316. The transceiver 1314 may be configured to both transmit and receive cellular network signals, wireless data signals, or other types of signals via the antenna 1316, depending on the nature of the mobile device 1300. Further, in some configurations, a GPS receiver 1318 may also make use of the antenna 1316 to receive GPS signals.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment

What is claimed is:

1. A viewing device comprising:
a transparent acousto-optical display configured to display virtual content; and
an augmented reality (AR) device coupled to the transparent acousto-optical display, the AR device comprising a hardware processor including an AR application configured to dynamically adjust optical properties of the transparent acousto-optical display and control a depth of field of the virtual content displayed in the transparent acousto-optical display based on the optical properties.

2. The viewing device of claim 1, wherein the transparent acousto-optical display comprises a transparent display coupled to an optical element, and
wherein the AR application is configured to dynamically adjust optical properties of the optical element to control the depth of field of the virtual content displayed in the transparent display.

3. The viewing device of claim 2, wherein the AR device comprises:
a sensor configured to capture an image of an object viewed by a user of the viewing device through the transparent acousto-optical display, and to determine a focal depth of the object relative to the transparent acousto-optical display;
a display controller coupled to the transparent display, the display controller being configured to communicate the virtual content to be displayed in the transparent display; and
an acousto-optical modulator coupled to the optical element, the acousto-optical modulator being configured to generate and modulate a frequency of a signal to the optical element to dynamically adjust a density of a material of the optical element and affect diffraction properties of the optical element, the diffraction properties of the optical element affecting the depth of field of the virtual content displayed in the transparent display.

4. The viewing device of claim 3, wherein the AR application comprises:
a recognition module configured to identify the object depicted in the image captured with the sensor;
an AR rendering module configured to retrieve the virtual content associated with the object, and to communicate a three-dimensional model of the virtual content to the display controller; and
a dynamic depth encoder configured to determine the frequency of the signal based on the focal depth of the object relative to the transparent acousto-optical display, and to communicate the determined frequency of the signal to the acousto-optical modulator.

5. The viewing device of claim 4, wherein the AR rendering module comprises:
an AR content module configured to access the three-dimensional model of the virtual content from a library of virtual content; and
an AR visualization module configured to render the three-dimensional model of the virtual content.

6. The viewing device of claim 4, wherein the dynamic depth encoder comprises:
an AR size computation module configured to compute a size of the three-dimensional model of the virtual content based on the depth of the object; and
a depth computation module configured to compute a depth of field of the three-dimensional model of the virtual content based on the focal depth of the object.

7. The viewing device of claim 6, wherein the dynamic depth encoder is configured to monitor the focal depth of the object and to dynamically adjust at least one of the size of the three-dimensional model of the virtual content and the depth of field of the three-dimensional model of the virtual content based on the monitored focal depth of the object.

8. The viewing device of claim 2, wherein the transparent display comprises at least one of a transparent organic light-emitting diode (OLED) and a reflective display coupled to a projection device external to the reflective display.

9. The viewing device of claim 2, wherein the optical element comprises at least one of a transparent waveguide and a holographic grating.

10. The wearable device of claim 1, wherein the viewing device comprises a transparent visor of a helmet, the transparent visor including the transparent acousto-optical display.

11. A method comprising:
adjusting optical properties of a transparent acousto-optical display;
controlling a depth of field of virtual content in a transparent acousto-optical display based on the optical properties; and
displaying the virtual content with the corresponding depth of field in the transparent acousto-optical display.

12. The method of claim 11, further comprising:
dynamically adjusting optical properties of an optical element of the transparent acousto-optical display to control the depth of field of the virtual content displayed in a transparent display coupled to the optical element.

13. The method of claim 12, further comprising:
capturing an image of an object viewed by a user of the viewing device through the transparent acousto-optical display with a sensor;
determining a focal depth of the object relative to the transparent acousto-optical display;
communicating the virtual content to a display controller coupled to the transparent display; and
generating and modulating a frequency of a signal to the optical element with an acousto-optical modulator coupled to the optical element, the acousto-optical modulator configured to dynamically adjust a density of a material of the optical element and affect diffraction properties of the optical element, the diffraction properties of the optical element affecting the depth of field of the virtual content displayed in the transparent display.

14. The method of claim 13, further comprising:
identifying the object depicted in the image captured with the sensor;
retrieving the virtual content associated with the object;
communicating a three-dimensional model of the virtual content to the display controller; and
determining the frequency of the signal based on the focal depth of the object relative to the transparent acousto-optical display, and to communicate the determined frequency of the signal to the acousto-optical modulator.

15. The method of claim 14, further comprising:
accessing the three-dimensional model of the virtual content from a library of virtual content; and
rendering the three-dimensional model of the virtual content.

16. The method of claim 14, further comprising:
computing a size of the three-dimensional model of the virtual content based on the focal depth of the object; and
computing a depth of field of the three-dimensional model of the virtual content based on the focal depth of the object.

17. The method of claim 16, further comprising:
monitoring the focal depth of the object; and
dynamically adjusting at least one of the size of the three-dimensional model of the virtual content and the depth of field of the three-dimensional model of the virtual content based on the monitored focal depth of the object.

18. The method of claim 12, wherein the transparent display comprises at least one of a transparent organic light-emitting diode (OLED) and a reflective display coupled to a projection device external to the reflective display.

19. The method of claim 12, wherein the optical element comprises at least one of a transparent waveguide and a holographic grating.

20. A non-transitory machine-readable storage medium, tangibly embodying a set of instructions that, when executed by at least one processor, causes the at least one processor to perform a set of operations comprising:
adjusting optical properties of a transparent acousto-optical display;
controlling a depth of field of virtual content in a transparent acousto-optical display based on the optical properties; and
displaying the virtual content with the corresponding depth of field in the transparent acousto-optical display.
